(19) United States
(12) Patent Application Publication
(10) Pub. No.: US 2012/0311836 A1
(43) Pub. Date: Dec. 13, 2012

(54) DIE EXTRACTOR

(75) Inventors: JIAN-ZHONG HU, Shenzhen City (CN); DU-XI GAO, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/307,181

(22) Filed: Nov. 30, 2011

(30) Foreign Application Priority Data
Jun. 8, 2011 (CN) 201110152197.7

(51) Int. Cl. B23P 19/04

(52) U.S. Cl. 29/263

(57) ABSTRACT

A die extractor is used for pulling a workpiece out of a mold assembly, and includes a screw, a connection assembly and a nut assembly. The shaft defines a screw hole at one end of the shaft and an external screw thread. The nut assembly defines an inner screw thread. One end of the connection assembly is rotatably connected to the workpiece, the other end of the connection assembly is rotatably fixed in and connected to the screw hole of the shaft. The shaft passes through the nut assembly, the nut assembly may be twisted to drive the shaft and the connection assembly to rotate in a preset direction and the connection assembly pulls the workpiece out from the mold assembly.

### BACKGROUND

1. Technical Field

The disclosure generally relates to a die extractor.

2. Description of the Related Art

Dies are used for shaping material generally and include a number of screws, stop dowels and other fixing members. In maintenance, the fixing members (e.g., screws and stop dowels) need to be extracted from the die during disassembly of the die. However, currently fixing members are extracted manually, which is laborious and inefficient.

Therefore, there is room for improvement within the art.

### BRIEF DESCRIPTION OF THE DRAWINGS

Many aspects of a die extractor can be better understood with reference to the following drawings. The components in the drawings are not necessarily drawn to scale, the emphasis instead being placed upon clearly illustrating the principles of the die extractor. Moreover, in the drawings, like reference numerals designate corresponding parts throughout the several views. Wherever possible, the same reference numbers are used throughout the drawings to refer to the same or like elements of an embodiment.

FIG. 1 is a disassembled view of a die extractor, according to an embodiment of the disclosure.

FIG. 2 is an assembled view of the die extractor shown in FIG. 1 of the disclosure.

FIG. 3 is a cross-sectional view of the assembled die extractor taken along line III-III of FIG. 2.

### DETAILED DESCRIPTION

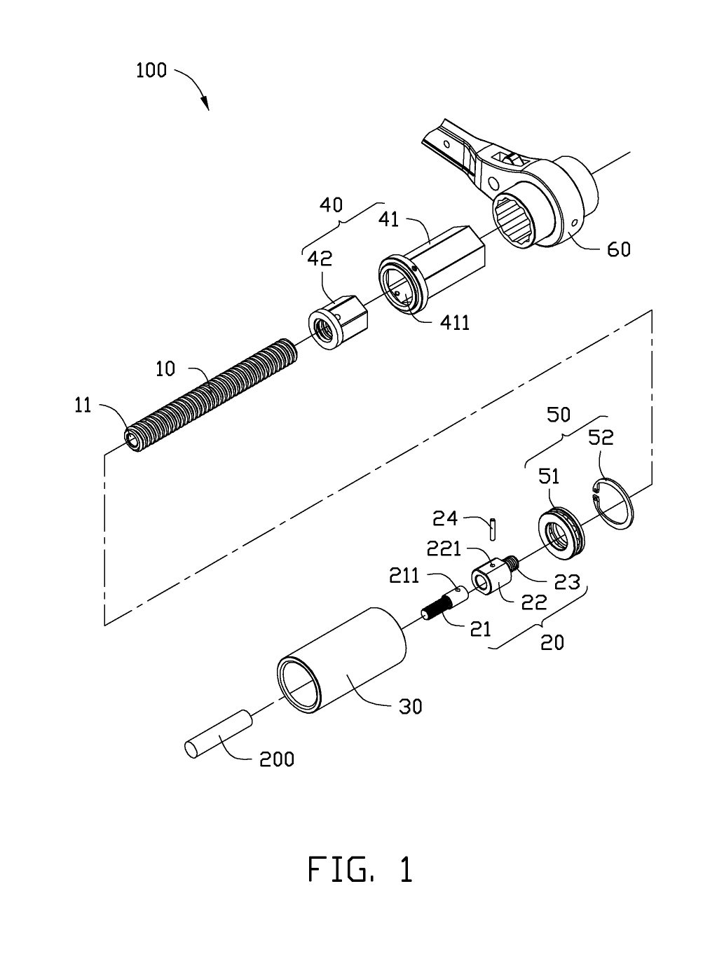

FIG. 1 is disassembled view of a die extractor 100, according to an embodiment of the disclosure. In this embodiment, the die extractor 100 includes a shaft 10, a connection assembly 20, a protection barrel 30, a nut assembly 40, and a transmission assembly 50.

In this embodiment, the shaft 10 is a substantially cylindrical body and defines an external screw thread. The shaft 10 defines a screw hole 11 in one end of the shaft 10.

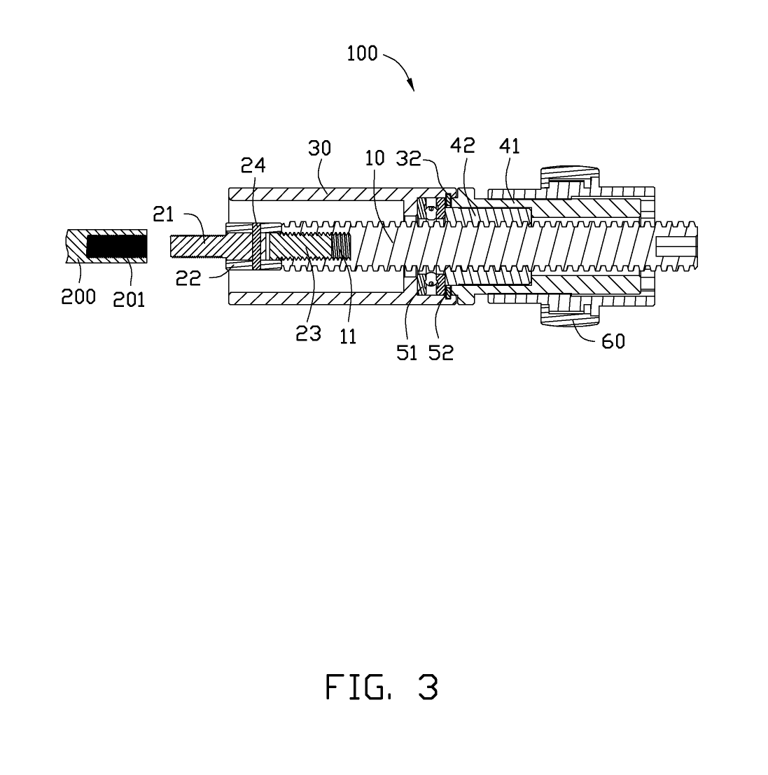

The connection assembly 20 includes a pull rod 21, a connecting portion 22, and a connecting rod 23. In this embodiment, the pull rod 21 is a substantially cylindrical rod and defines an external screw thread. The size and shape of the pull rod 21 (to connect and pull out from a workpiece 200) are substantially the same as those of the workpiece 200 such as the positioning screws and stop dowels. The pull rod 21 defines a through positioning hole 211. Referring to FIG. 3, the workpiece 200 defines a thread hole 201 at one end of the workpiece 200, and the thread hole 201 include an inner screw thread 201.

The connecting portion 22 is a substantially hollow cylindrical body for connecting the pull rod 21 and the connecting rod 23. The connecting portion 22 defines a connection hole 221 corresponding to the positioning hole 211. In this embodiment, the pull rod 21 is removably received within the connecting portion 22. When the pull rod 21 is located in the connecting portion 22, the connection hole 221 aligns with the position hole 211, and a locking member 24 (e.g., a bolt) passes through the connection hole 221 and the positioning hole 211 to fix and secure the pull rod 21 into the connecting portion 22.

The connecting rod 23 is a substantially cylindrical body and defines an external screw thread. One end of the connecting rod 23 is mechanically connected and fixed within the connecting portion 22, for example by a threaded connection. The other end of the connecting rod 23 is rotatably received within the screw hole 11 of the shaft 10, so the connecting rod 23 is connected to the screw hole 11, for example by a threaded connection.

The protection barrel 30 is a substantially hollow cylindrical body and is fixed onto the nut assembly 40 through the transmission assembly 50. The protection barrel 30 is configured for receiving the shaft 10 and the connection assembly 20 and providing an operating space when extracting the workpiece 200.

The nut assembly 40 includes a nut member 41 and a screw member 42. In this embodiment, the screw member 42 can be a substantially hollow polyhedron (e.g., a hexahedron) which defines an inner screw thread corresponding to the external screw thread of the shaft 10. The shaft 10 is rotatably connected to and received in the screw member 42 through the threaded connection. The nut member 41 is the same substantially hollow polyhedron such as a hexahedron, and defines a through hole 411 with the same size and shape as the screw member 42. Thus, the screw member 42 can be partially and removably received within the through hole 411 of the nut member 41, and the other part of the screw member 42 is exposed from the through hole 411.

Further referring to FIG. 3, the transmission assembly 50 includes a thrust bearing 51 and a retaining ring 52. In this embodiment, the size and shape of the bearing 51 substantially matches with the inner space of the protection barrel 30, so the bearing 51 can be removably received and secured within the protection barrel 30. The circlip (retaining ring 52) is a fastener that holds the extended portion of the screw member 42, to complete the assembly of the screw member 42 to the nut member 41. The retaining ring 52 is partially exposed from the nut member 41, and the exposed portion of the retaining ring 52 is removably received within a slot 32 of the protection barrel 30. Thus, the nut assembly 40 and the protection barrel 30 are held together by the retaining ring 52.

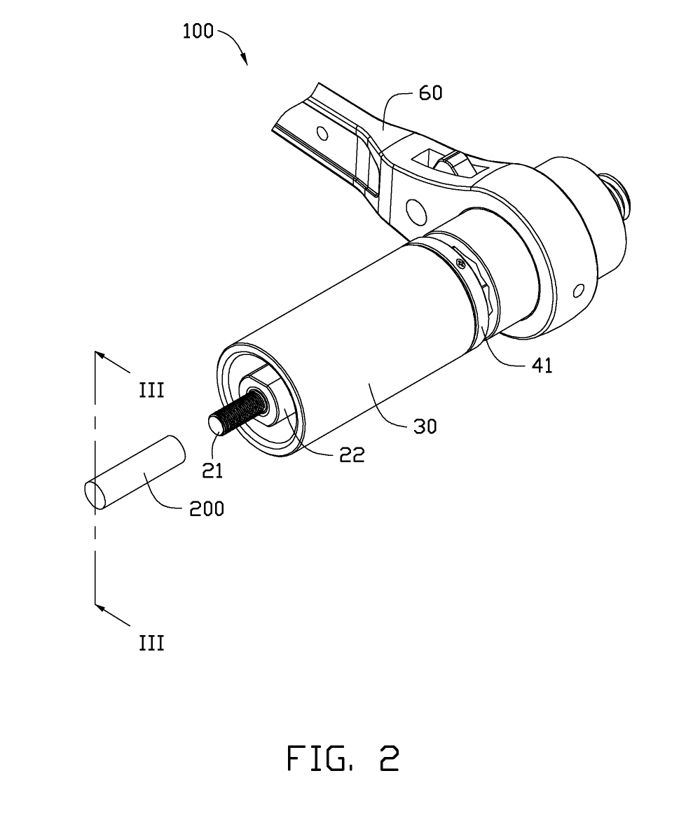

Referring to FIGS. 2 and 3, in use, the pull rod 21 is aligned with and received within the connecting portion 22, the locking member 24 passes through the connection hole 221 and the positioning hole 211 to fix the pull rod 21 into the connecting portion 22. The connecting rod 23 is rotatably received and fixed within the screw hole 11 of the shaft 10 to assemble the connection assembly 20 to the shaft 10. The pull rod 21 is rotatably connected to the thread hole 201 of the workpiece 200 through screwing one end of the shaft 10 (e.g., in a clockwise direction). The protection barrel 30 covers and shields the connection assembly 20 and the shaft 10. The bearing 51 is received in the protection barrel 30, and the shaft 10 passes through the bearing 51. The shaft 10 is rotatably connected to and passes through the screw member 42 via threaded connection. The screw member 42 is received within the nut member 41, and the retaining ring 52 holds the exposed portion of the screw member 42 to fix the screw member 42 to the nut member 41. The exposed portion of the retaining ring 52 is received in the slot 32 of the protection barrel 30, so the protection barrel 30 and the nut assembly 40 are connected together by the retaining ring 52. The nut member 41 of the nut assembly 40 is rotated (e.g., in a counter-clockwise direction) to exert a pulling force, from the screw member 42 to the shaft 10, and the shaft 10 rotatably moves away from the workpiece 200. Thus, the shaft 10 drives the pull rod 21 to extract the workpiece 200 (e.g., screws and stop dowels) from a mold assembly.

Moreover, the die extractor 100 further includes an operation assembly 60. In this embodiment, the operation assembly 60 can be a ratchet wrench, and is used to turn the nut member 41 incrementally to drive the pull rod 21 to extract the workpiece 200 out.

In addition, the pull rod 21 can be replaced and changed according to the shape and size of the thread hole 201 of the workpiece 200 to accommodate different types of workpiece.

In the die extractor 100 of the present disclosure, the nut assembly 40 can transmit a very strong turning force to the shaft 10, driving the pull rod 21 to move back, so that the pull rod 21 can quickly extract and pull out the workpiece 200 from the mold assembly. Moreover, the die extractor 100 has a simple structure and is easy to operate and assemble, and does not need a C-clamp or other auxiliary tool(s).

In the present specification and claims, the word “a” or “an” preceding an element does not exclude the presence of a plurality of such elements. Further, the word “comprising” does not exclude the presence of elements or steps other than those listed.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of this exemplary disclosure to the full extent indicated by the broad general meaning of the terms in which the appended claims are expressed.

What is claimed is:

1. A die extractor used for extracting a workpiece from a mold assembly, the die extractor comprising:
a shaft defining an external screw thread and a screw hole at one end of the shaft;
a nut assembly defining an inner screw thread; and
a connection assembly, wherein one end of the connection assembly is rotatably connected to the workpiece, the other end of the connection assembly is rotatably fixed in and connected to the screw hole of the shaft, the shaft passes through the nut assembly, the nut assembly is screwed to drive the shaft and the connection assembly to rotate in a preset direction, the connection assembly pulling the workpiece out of the mold assembly.

2. The die extractor as claimed in claim 1, wherein the connection assembly comprises a pull rod, the pull rod defines an external screw thread, the size and shape of the pull rod matches with that of the workpiece to connect and pull out the workpiece, and the pull rod defines a positioning hole extending through the pull rod.

3. The die extractor as claimed in claim 2, wherein the connection assembly comprises a connecting portion, the connecting portion connects the pull rod and the connecting rod, the connecting portion defines a connection hole corresponding to the positioning hole of the pull rod, the pull rod removably located in the connecting portion, the connection hole is aligned with the position hole, a locking member passes through the connection hole and the positioning hole to fix and secure the pull rod to the connecting portion.

4. The die extractor as claimed in claim 3, wherein the connection assembly comprises a connecting rod, the connecting rod defines an external screw thread, one end of the connecting rod is mechanically connected and fixed within the connecting portion, and the other end of the connecting rod is rotatably received within the screw hole of the shaft.

5. The die extractor as claimed in claim 1, wherein the nut assembly comprises a nut member and a screw member, the screw member is a substantially hollow polyhedron and defines an inner screw thread corresponding to the external screw thread of the shaft, the shaft is rotatably connected to and received in the screw member using threaded connection, and the nut member is a hollow polyhedron and defines a through hole, the screw member is partially and removably received within the through hole of the nut member, and the other part of the screw member is exposed from the through hole.

6. The die extractor as claimed in claim 5, further comprising a protection barrel, wherein the protection barrel is a substantially hollow cylindrical body and is fixed on the nut assembly by the transmission assembly, and the protection barrel is configured for receiving the shaft and the connection assembly and providing an operating space when extracting the workpiece.

7. The die extractor as claimed in claim 6, further comprising a transmission assembly, wherein the transmission assembly comprises a bearing, the size and shape of the bearing substantially matches with that of the inner space of the protection barrel, and the bearing is removably received and secured within the protection barrel.

8. The die extractor as claimed in claim 7, wherein the transmission assembly further comprises a retaining ring, the retaining ring is a fastener that holds the extended portion of the screw member to assemble the screw member to the nut member, the retaining ring is partially exposed from the nut member, and the exposed portion of the retaining ring is removably received within a slot of the protection barrel, and the nut assembly and the protection barrel are connected together by the retaining ring.

9. The die extractor as claimed in claim 5, further comprising an operation assembly, wherein the operation assembly is a ratchet wrench used to turn the nut member using a back-and forth motion to transmit power to the shaft to drive the pull rod to pull out and extract the workpiece.

10. A die extractor used for pulling a workpiece out of a mold assembly, the die extractor comprising:
a shaft defining a screw hole at one end of the shaft;
a connection assembly comprising:
a pull rod connected to the workpiece;
a connecting portion removably connected to another end of the pull rod; and
a connecting rod connected to another end of the connecting portion; and
a nut assembly, wherein the other end of the connecting rod is rotatably received and fixed within the screw hole of the shaft, the shaft rotatably screws through the nut assembly, the nut assembly is screwed on the shaft and transmits power to the shaft, and the shaft drives the pull rod to rotate in a predetermined direction to extract the workpiece out of the mold assembly.

11. The die extractor as claimed in claim 10, wherein the a pull rod defines an external screw thread, the size and shape of the pull rod matches with that of the workpiece to connect and pull out the workpiece, and the pull rod defines a positioning hole extending through the pull rod.

12. The die extractor as claimed in claim 11, wherein the connecting portion defines a connection hole corresponding to the positioning hole of the pull rod, the pull rod removably located in the connecting portion, the connection hole is aligned with the position hole, a locking member passes through the connection hole and the positioning hole to fix and secure the pull rod to the connecting portion.

13. The die extractor as claimed in claim 10, wherein the nut assembly comprises a screw member, the screw member is a substantially hollow polyhedron and defines an inner screw thread corresponding to the external screw thread of the shaft, the shaft is rotatably connected to and received in the screw member using threaded connection.

14. The die extractor as claimed in claim 13, wherein the nut assembly further comprises a nut member, the nut member is a hollow polyhedron and defines a through hole, the screw member is partially and removably received within the through hole of the nut member, and the other part of the screw member is exposed from the through hole.

15. The die extractor as claimed in claim 14, further comprising a protection barrel, wherein the protection barrel is a substantially hollow cylindrical body and is fixed on the nut assembly by the transmission assembly, and the protection barrel is configured for receiving the shaft and the connection assembly and providing an operating space when extracting the workpiece.

16. The die extractor as claimed in claim 15, further comprising a transmission assembly, wherein the transmission assembly comprises a bearing, the size and shape of the bearing substantially matches with that of the inner space of the protection barrel, and the bearing is removably received and secured within the protection barrel.

17. The die extractor as claimed in claim 16, wherein the transmission assembly further comprises a retaining ring, the retaining ring is a fastener that holds the extended portion of the screw member to assemble the screw member to the nut member, the retaining ring is partially exposed from the nut member, and the exposed portion of the retaining ring is removably received within a slot of the protection barrel, and the nut assembly and the protection barrel are connected together by the retaining ring.

18. The die extractor as claimed in claim 14, further comprising an operation assembly, wherein the operation assembly is a ratchet wrench used to turn the nut member using a back-and forth motion to transmit power to the shaft to drive the pull rod to pull out and extract the workpiece.
